(19) United States
(12) Patent Application Publication
(10) Pub. No.: US 2002/0116295 A1
(43) Pub. Date: Aug. 22, 2002

(54) Method and system for selling or purchasing commodities via network

(75) Inventors: Hiroyasu Shino, Kawasaki (JP); Kazuhira Tanno, Kawasaki (JP); Toshiya Nakajima, Kawasaki (JP); Yasuhiro Hirano, Kawasaki (JP); Genichi Sonda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/863,254

(22) Filed: May 24, 2001

(30) Foreign Application Priority Data
Feb. 20, 2001 (JP) 2001-042637

(51) Int. Cl. G06F 17/60

(52) U.S. Cl. 705/27

(57) ABSTRACT

The present invention provides a selling system for providing an interface for customers in the online sale of commodities as if the customer actually went to a shop and evaluated each article according to the purchase request. This selling system has a receiver for receiving instruction information regarding an arbitrary display manner of an arbitrary individual commodity selected by a user from a user terminal, means for outputting to a photographing robot, a first photographing request for acquiring image information at this moment according to the arbitrary display manner of the selected individual arbitrary commodity itself, which is designated in the instruction information, and a transmitter for transmitting to the user terminal, the image information of the selected individual commodity itself, which is photographed by the photographing apparatus.

### TECHNICAL FIELD OF THE INVENTION

The present invention relates to technology for selling or purchasing merchandise via network.

### BACKGROUND OF THE INVENTION

For example, Japanese laid-open patent application 2000-99612 discloses following technology. That is, a camera to be controlled by a relay server is set in a shopping center and a store, and camera angle information related with all images, which can be photographed by the camera, is preliminarily stored in a DB in a WWW (World Wide Web) server. Then, if a request for the display of an electric catalog from a client requires images in a real time, the WWW server retrieves the DB, decides a camera number and camera angle or the like, and transmits a request for the delivery of images to the relay server. The relay server transmits the images obtained by controlling the camera to the WWW server, and the WWW server prepares a home page, based on the transmitted images, and transfers it to the clients. Then, the electronic catalog is displayed, and the client can purchase merchandise while moving in the store, and capturing the actual in-store situation by clicking a direction to which the client wants to move or merchandise which the client wants to see on the home page.

As shown in FIG. 27 of this application in detail, the client enters this system from a screen 3020, selects a shopping center among shopping centers A, B and C on a screen 3021, causes the system to display an image of the shopping center in a real time on a screen 3023, and causes it to change the camera angle according to the selection of an upward, downward, right, left, or zoom button. Then, the system displays an image of the front of the selected shop A on a screen 3023, displays a sketch image of a floor, in which an entrance is provided, on a screen 3024 in a real time by clicking the entrance of this shop, and, by clicking a particular showcase, displays an image of the front of the showcase in a real time on a screen 3025. In this application, it is possible for the client to instruct the system to acquire a sketch image of another floor in a real time on the screen 3024. In addition, it is possible to acquire an image of the showcase whose angle is changed according to the selection of the upward, downward, right, left, or zoom button, in a real time on a screen 3035. Then, if a commodity, which is displayed on a screen 3036, is clicked, as shown on a screen 3036, information regarding the commodity, which is registered in advance, and an image of the detailed commodity picture (front, side, or top), which is photographed preliminarily, are displayed.

If the technology of this application is adopted, a lot of cameras, which do not move, have to be provided in the shopping centers and the shops. Therefore, this technology has a shortcoming in which a feeling such as being watched is given to customers, who normally come to the shopping centers and the shops. In addition, it is possible to acquire an image in a real time until a commodity is selected, that is, until the screen 3035, but as for the details of a commodity, clients of this system can only look at an image of the same kind of the commodity, which is preliminarily photographed. Namely, the state of each commodity cannot be evaluated in detail. Furthermore, clients cannot purchase the commodity itself, which is selected on the screen 3035. In addition, because the image, which is photographed preliminarily, is used, clients cannot look at the commodity itself in an arbitrary angle. This causes big problems when clients purchase merchandise, which has different contents or states for each article, such as perishable foods, or secondhand goods.

In addition, Japanese laid-open patent application 7-182419 discloses a purchasing system. In the purchasing system, a seller side directly performs pricing of merchandise in a producing district, and during pricing, data is prepared as media information, which includes a highly detailed television image of merchandise to judge the value of the commodity or measurement data to grasp the quality of the commodity. Then, the media information is transmitted to a buyer side via B-ISDN line. The media information is transformed on the buyer side into information in a form the buyer can recognize, and is output to the buyer side. The buyer side judges the value of the commodity based on the output information, and information whether purchased or not and information regarding the price is output to the seller side.

However, since it is assumed that this system is used in an auction in a fish market, particular kinds of fishes or fish unloaded in particular producing districts are to be auctioned off in an order predetermined by the producing districts or the fish market. Thus, each buyer has to follow it, and the media information is not displayed based on an arbitrary purchasing desire of each buyer. In addition, an example for the quality data is disclosed in which the system automatically collects the quality data according to a request from the buyer such as a retailer in the fish market, and transmits it to the buyer terminal. As for the television image, it does not disclose that each buyer can instruct the camera angle, however, it only discloses that the voice someone of the buyers speaks in the fish market is transmitted as voice information to the producing district, and in response to the voice information, the seller, who is a human being, not a machine, in the fish market changes the camera angle. The camera angle control is limited to the disclosed manner in this system. Furthermore, this application does not assume the sale in the shop. Therefore, it does not disclose a viewpoint in which the television image is photographed while moving the camera in the producing district, and a viewpoint in which the customer purchasing interest arises by photographing the television image during the movement.

### SUMMARY OF THE INVENTION

As described above, the conventional art cannot provide an online merchandise purchasing manner very similar to a shopping in a real world, such that a customer actually goes to a shop, moves to a corner for a purchase plan commodity, evaluates each article among the same kind of the purchase plan commodity, and finally selects one article to be purchased.

Thus, an object of the present invention is to provide technology for providing an interface for customers in the online sale of the commodities as if the customer actually went to a shop and evaluated each article according to the purchase desire.

A method for selling a commodity via a network, which is the first aspect of the present invention, comprises the steps of: if instruction information (for example, turn over up and down, turn over right and left, zoom, etc.) regarding an arbitrary display manner of an arbitrary individual commodity selected by a user is received from a user terminal, outputting to a photographing apparatus (for example, a robot 73 in the preferred embodiment), a first photographing request for acquiring image information at this moment according to the arbitrary display manner of the selected individual arbitrary commodity itself, and transmitting to the user terminal (for example, directly from the photographing apparatus, or by relaying through a server performing this selling method) the image information of the selected individual commodity itself, which is photographed by the photographing apparatus.

With this configuration, it becomes possible for the user to evaluate the individual commodity, and to confirm the freshness and size and so on of the perishable foods, especially. Therefore, the user can perform the shopping with a feeling as if the user actually went to the shop and selected the very best commodity among the same kind of purchase plan commodities.

In addition, it is possible to configure the first aspect of the present invention to comprises further steps of: if selection information of a purchase plan commodity is received from the user terminal, outputting to the photographing apparatus, a second request for acquiring image information for the purchase plan commodity, and transmitting to the user terminal, image information of the purchase plan commodity photographed by the photographing apparatus and image information until the purchase plan commodity is photographed by the photographing apparatus (for example, in the preferred embodiment, image information while the robot 73 is moving.). It becomes possible to perform the shopping with a feeling as if the user actually walked around the corners in the shop. With this configuration, it is also possible to raise the customer purchasing interests for commodities other than the purchase plan commodities.

Furthermore, it is possible to configure the first aspect of the present invention to comprise further steps of: if a purchase instruction for the selected individual commodity is received from the user terminal, acquiring identification information of the selected individual commodity itself (for example, from a bar code. It is also possible to assign the identification information to the commodity itself at this timing.), and transmitting to the user terminal, the identification information of the selected individual commodity itself. With this configuration, it becomes possible for the user to confirm whether or not the individual article itself selected via the network by the user is actually sent.

A method for purchasing a commodity via a network, which is the second aspect of the present invention, comprises the steps of: receiving from a server, and displaying on a display device, image information of an arbitrary individual commodity selected by a user, in response to an instruction input for an arbitrary display manner of the individual commodity itself by the user, transmitting to the server, instruction information regarding the arbitrary display manner, and receiving from the server, and displaying on the display device, image information according to the arbitrary display manner of the individual commodity itself.

At the user terminal, according to the instruction from the user, a reverse image and zoom image of the selected commodity itself at that time are displayed.

The method for selling a commodity can be implemented by a combination of a program and a computer hardware, which is a computer system for selling a commodity. In this case, the program is stored on a storage medium, such as a flexible disk, a CD-ROM or a magneto-optical disk, or in a storage device, such as a semiconductor memory or a hard disk, while the intermediate processing results are temporarily stored in the memory. The program may be distributed via a computer network.

### BRIEF DESCRIPTION OF THE DRAWINGS

FIG. 1 is a diagram showing the outline of the system in an embodiment of the present invention;

FIG. 2 is a diagram showing an example of a member information table;

FIG. 3 is a diagram showing an example of an in-store layout information table;

FIG. 4 is a diagram showing an example of a shop/commodity information table;

FIG. 5 is a diagram showing an example of an order delivery information table;

FIG. 6 is a diagram showing an example of a price collection management table;

FIG. 7 is a flowchart showing a processing flow (part 1) in an embodiment of the present invention;

FIG. 8 is a diagram showing an example of a display screen for selecting a menu or commodity order processing;

FIG. 9 is a diagram showing an example of a display screen for a cooking menu;

FIG. 10 is a diagram showing an example of a display screen for a recipe;

FIG. 11 is a diagram showing an example of a display screen for selecting purchase request commodities and a shop;

FIG. 12 is a diagram showing an operation example (part 1) on the display screen for selecting purchase request commodities and a shop;

FIG. 13 is a diagram showing an operation example (part 2) on the display screen for selecting purchase request commodities and a shop;

FIG. 14 is a flowchart showing a processing flow (part 2) in the embodiment of the present invention;

FIG. 15 is a diagram showing a n example of a display screen for showing an association figure between selected commodities and the corner layout within the shop;

FIG. 16 is a diagram to explain a moving route of the corners by a robot;

FIG. 17 is a diagram showing an example of a display screen including a layout within the shop and image information while moving;

FIG. 18 is a flowchart showing a processing flow (part 3) in the embodiment of the present invention;

FIG. 19 is a flowchart showing a processing flow (part 4) in the embodiment of the present invention;

FIG. 20 is a diagram showing an example of a display screen for the evaluation and order;

FIG. 21 is a flowchart showing a processing flow (part 5) in the embodiment of the present invention;

FIG. 22 is a flowchart showing a processing flow (part 6) in the embodiment of the present invention;

FIG. 23 is a diagram showing an example of a display screen for inputting conditions for the delivery request;

FIG. 24 is a flowchart showing a processing flow (part 7) in the embodiment of the present invention; and

FIG. 25 is a diagram showing an example of a display screen for the order confirmation.

### DETAIL DESCRIPTION OF THE PREFERRED EMBODIMENTS

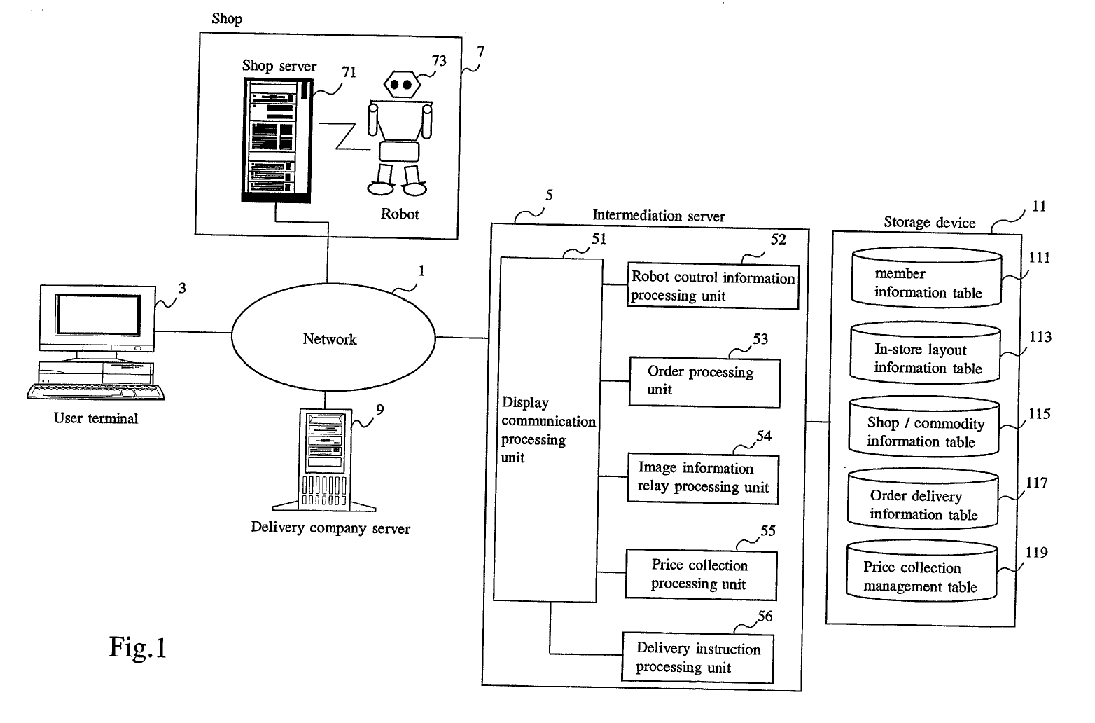

FIG. 1 shows a system outline in an embodiment of the present invention. A network 1, which is the Internet, for example, is connected with one or a plurality of user terminals 3, which have a web browser function, for example, an intermediation server 5, which is managed by this service provider and has a web server function, a shop server 71, which is provided in one or a plurality of shops 7, which take part in this service, and one or a plurality of delivery company servers 9, which are managed by the delivery companies, which cooperate to provide this service.

In the shop 7, the shop server 71 and at least one robot 73, which is controlled by this shop server 71, are provided. The shop server 71 communicates with the robot 73 by radio or wire.

The intermediation server 5 includes a display communication processing unit 51 to implement the web server function, a robot control information processing unit 52 for outputting a control command for the robot 73 in the shop 7, and receiving and processing control information from the robot 71 in the shop 7 or the shop server 73, an order processing unit 53 for performing an order from the customer, an image information relay processing unit 54 for receiving image information photographed by the robot 3 in the shop 7 and transferring to the user terminal 3, which is the requesting source, the image information, a price collection processing unit 55 for performing a processing for the price collection for the order, and a delivery instruction processing unit 56 for instructing a delivery company to deliver commodities ordered by the customers.

In addition, the storage device 11 in the intermediation server 5 includes a member information table 111, an in-store layout information table 113, a shop/commodity information table 115, an order delivery information table 117, and a price collection management table 119.

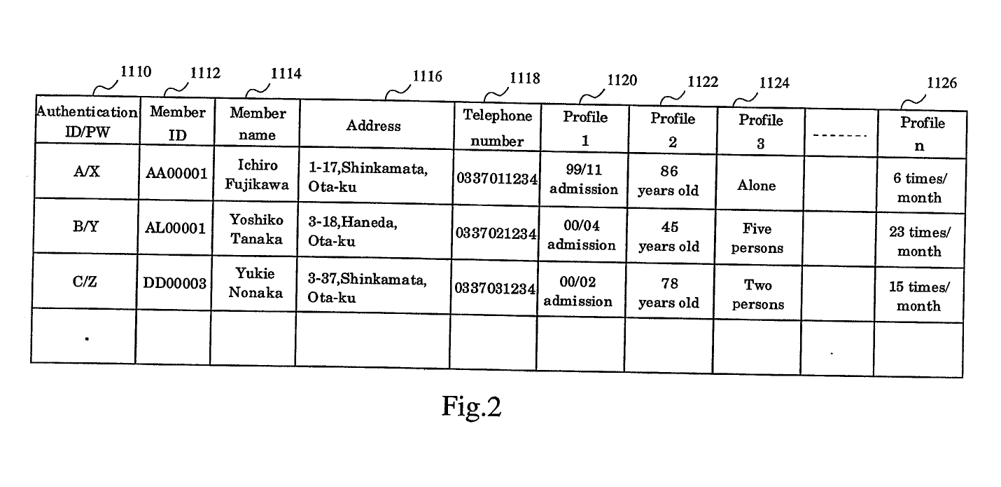

FIG. 2 shows an example of data stored in the member table 111. In the example of FIG. 2, an authentication ID and password are stored in an authentication ID/PW column 1110. A member ID is stored in a member ID column 1112, a member name in a member name column 1114, an address in an address column 1116, and a telephone number in a telephone number column 1118. Attribute information for each member is stored in a “profile 1” column 1120, a “profile 2” column 1122, a “profile 3” column 1124, . . . a “profile n” column 1126. In this example, information concerning admission year and month, age, the number of family who live with, the number of usages during one month and so on is stored in these columns. In addition, information regarding a method for the price collection, which is not shown in FIG. 2, may be stored.

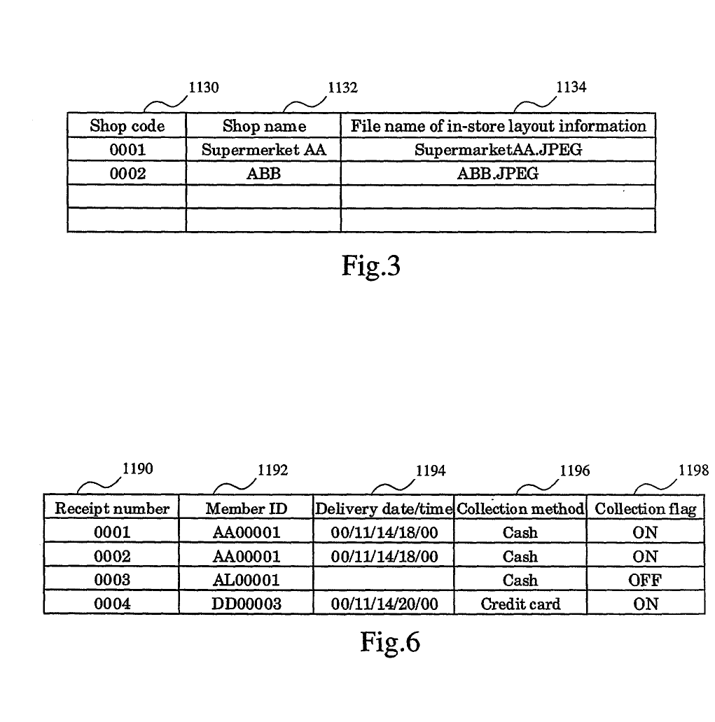

FIG. 3 shows an example of data stored in the shop layout information table 113. In an example of FIG. 3, a shop code is stored in a shop code column 1130, a shop name in a shop name column 1132, and a name of a file including in-store layout information in an in-store layout information file name column 1134. The shop layout information file itself is stored in another storage area in the storage device 11. In addition, JPEG file is indicated in this example as a file type, but other file types (for example, bmp, and gif) may be used for the image file.

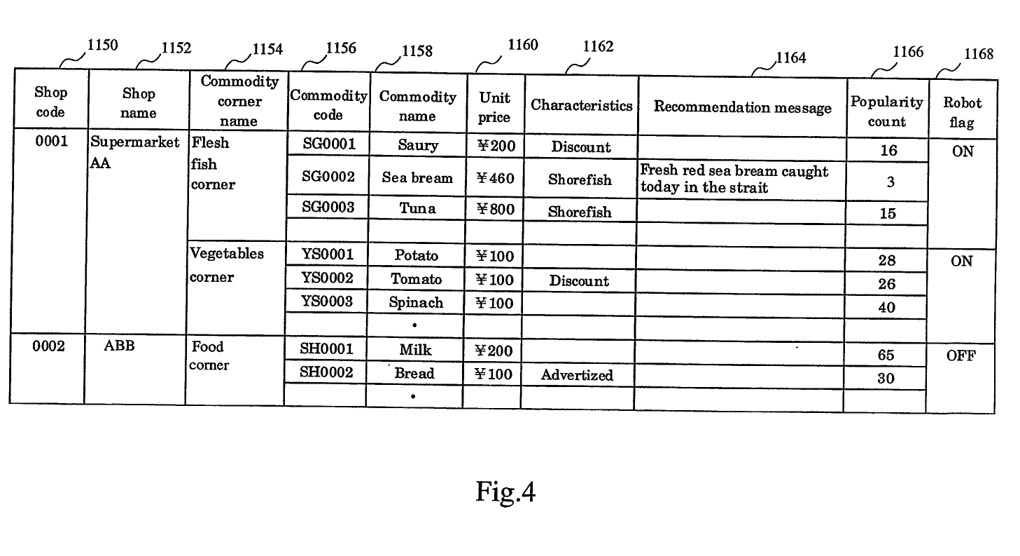

FIG. 4 shows an example of data stored in the shop/commodity information table 115. In the example of FIG. 4, a shop code is stored in a shop code column 1150, a shop name in a shop name column 1152, a commodity corner name for each shop in a commodity corner name column 1154, a commodity code for each commodity in a commodity code column 1156, a commodity name in a commodity name column 1158, a unit price for each commodity in a unit price column 1160, characteristics information for each commodity in a characteristics column 1162, a recommendation message in a recommendation message column 1164, the number of purchases by customers in a popularity count column 1166, and information whether or not a robot is provided in a robot flag column 1168. The commodity code and name indicate the kind of the commodity, and does not identify an individual article. Since a shop without a robot is unchanged from a conventional online shop, no further explanation is provided.

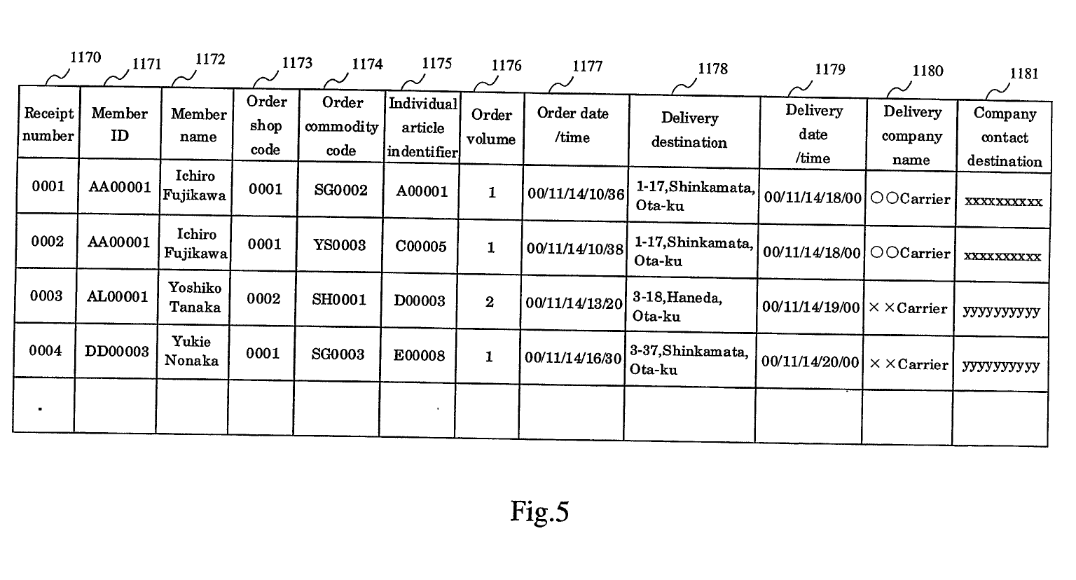

FIG. 5 shows an example of data stored in the order delivery information table 117. In the example of FIG. 5, an order receipt number is stored in a receipt number column 1170, a member ID of a member who performs an order in a member ID column 1171, the member name of that member in a member name column 1172, a shop code of a shop in which the order is performed in an ordered shop code column 1174, an individual article identifier for identifying the article itself selected by the user in an individual article identifier column 1175, an order volume of articles in an order volume column 1176, a date and time when the order is performed in an order date/time column 1177, a delivery destination of the ordered commodities in a delivery destination column 1178, a delivery date and time when the user requests in a delivery date/time column 1179, a delivery company name of a delivery company, which will deliver the ordered commodities, in a delivery company name column 1180, and information regarding a contact destination in a column 1181 for the company contact destination. If the order volume indicates the plural, a plurality of individual commodity identifiers may be stored in this table.

FIG. 6 shows an example of data stored in the price collection management table 119. In the example of FIG. 6, a receipt number is stored in a receipt number column 1190, a member ID of a customer who performs an order in a member ID column 1192, a date and time when the delivery is performed in a delivery date/time column 1194, a price collection method in a collection method column 1196, and a flag indicating whether the price has been collected (ON) or not yet (OFF) in a collection flag column 1198. In the example of FIG. 6, it is recorded for the receipt number 0001 and 0002 that the delivery company has already performed the price collection by cash. In the row of the receipt number 0003, the price collection by cash is indicated, but since the delivery is not completed, the collection flag indicates OFF. In the row of the receipt number 0004, the price collection by a credit card is indicated, and the delivery has been completed and the price collection has also been completed. For example, if the number of the price collection methods is only one, the collection method column 1196 does not have to be provided.

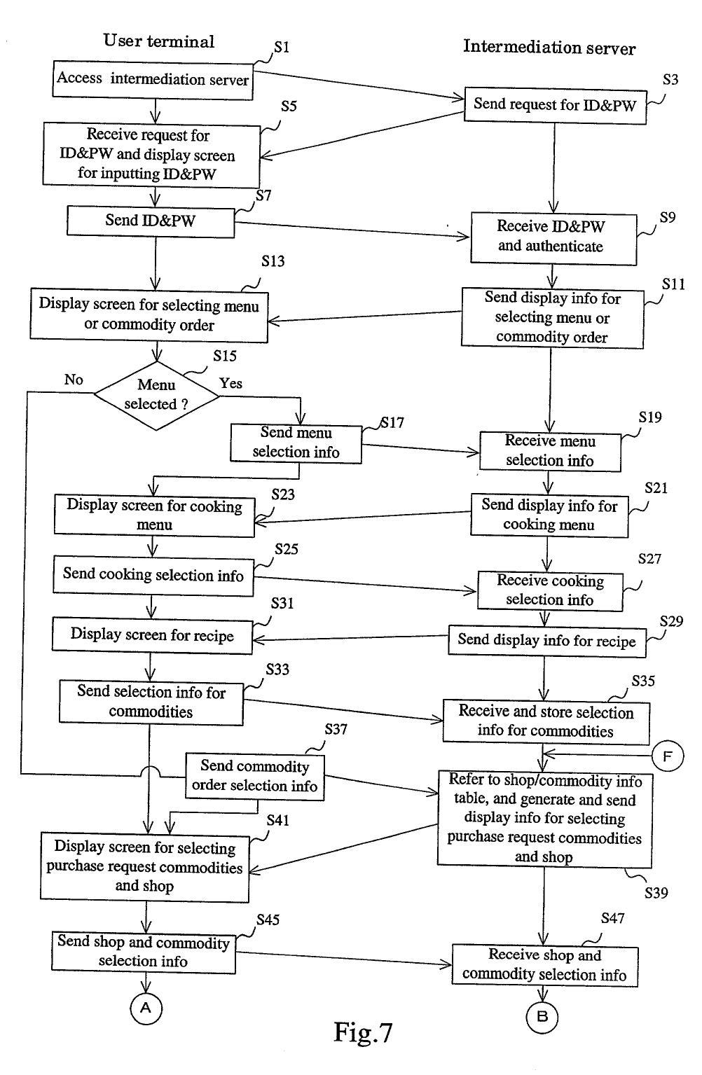

Next, a processing flow of the system shown in FIG. 1 is explained using FIG. 7 to FIG. 25. Firstly, a user operates the user terminal 3 and has it access the intermediation server 5 (step SI). In response to this access, the display communication processing unit 51 in the intermediation server 5 sent back a request for inputting an ID (a member ID) and a password to the user terminal 3 (step S3). The user terminal 3 receives the request for inputting an ID and a password, and displays on a display device a display screen for inputting an ID and a password (step S5). In response to this display, the user uses an input device of the user terminal 3, and inputs his or her ID and password.

The user terminal 3 transmits to the intermediation server 5, the input ID and password (step S7). If the display communication processing unit 51 in the intermediation server 5 receives the ID and the password from the user terminal 3, it refers to the member information table 111, and performs an authentication processing (step S9). If the authentication fails, the display communication processing unit 51 in the intermediation server 5 notifies the user terminal 3 of the failure in the authentication. If the authentication is successful, the display communication processing unit 51 transmits to the user terminal 3, display information (for example, HTML (Hyper Text Markup Language) file and image files if designated) for a screen for selecting a menu or commodity order processing (step S11).

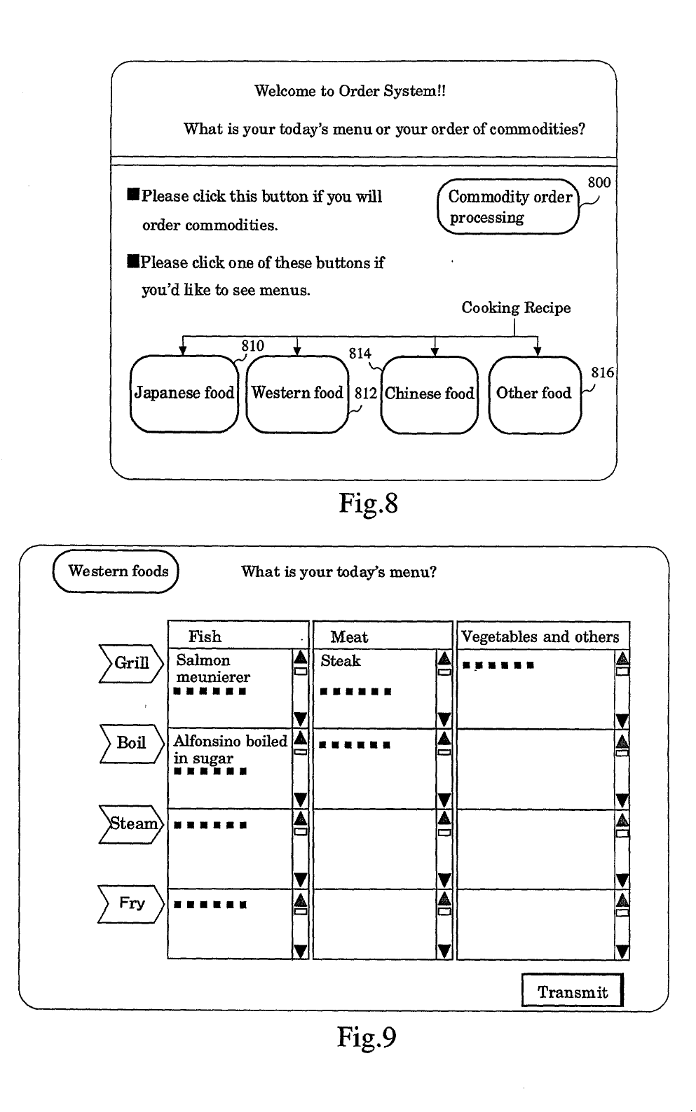

The user terminal 3 receives the display information for the screen for selecting a menu or commodity order processing and display on the display device, the screen (step S13). An example of the screen for selecting a menu or commodity order processing is shown in FIG. 8. In the example of FIG. 8, this screen for selecting a menu or commodity order processing includes a commodity order processing button 800, which is selected if the user selects an individual commodity, a Japanese food button 810, a western food button 812, a Chinese food button 814 and an other food button 816, which are used to select commodities from menus.

Therefore, the user looks at the screen for selecting a menu or commodity order processing, decides any of these methods for the commodity selection, and pushes either button. If the user selects the menu (step S15: Yes route), menu selection information indicating that any of Japanese, western, Chinese and other foods is selected, is transmitted to the intermediation server 5 (step S17). The display communication processing unit 51 in the intermediation server 5 receives from the user terminal 3, the menu selection information (step S19), and transmits to the user terminal 3, display information for a cooking menu screen (step S21). The user terminal 3 receives from the intermediation server 5, the display information for the cooking menu screen, and displays on the display device, the cooking menu screen (step S23).

FIG. 9 shows an example of the cooking menu screen if the western foods button is pushed. If the western is selected, the user can choose a favorite cooking from a matrix in which the cooking is categorized by rows for fish, meat, vegetables and other foods, and lines for grill, boil, steam and fry. When the user selects a cooking and clicks a transmit button on the screen, the user terminal 3 transmits to the intermediation server 5, cooking selection information (step S25). The display communication processing unit 51 in the intermediation server 5 receives the cooking selection information from the user terminal 3 (step S27), and transmits to the user terminal 3, display information for a screen for a recipe (step S29). The user terminal receives the display information for the screen for a recipe from the intermediation server 5 and displays on the display device, the screen (step S31).

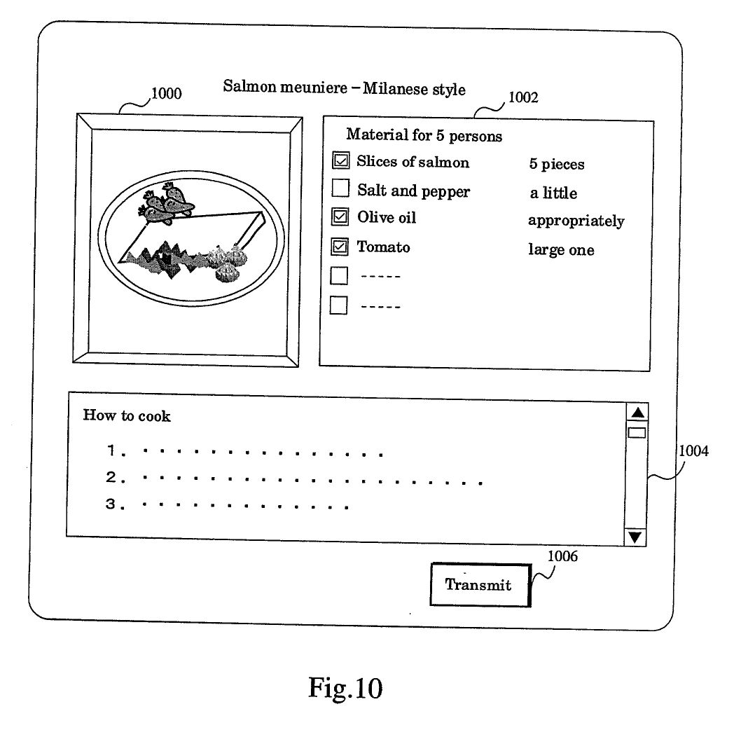

FIG. 10 shows an example of the screen for the recipe if “Salmon meuniere” is selected. In the example of FIG. 10, a cooking picture part 1000, a recipe part 1002 and a part 1004 for the explanation as to how to cook. If the user looks at this screen for the recipe and decides to cook this food, he or she clicks check boxes provided on the left side for each material included in the recipe part 1002. In the example of FIG. 10, slices of salmon, olive oil and a tomato are selected. Then, if the necessary materials are checked, the transmit button 1006 is clicked.

Then, the user terminal 3 transmits to the intermediation server 5, selection information for commodities, which correspond to materials (step S33). The display communication processing unit 51 in the intermediation server 5 receives and stores in a storage device, the selection information for commodities. Then, by referring to the shop/commodity information table 115, the intermediation server 5 generates and transmits to the user terminal 3, display information for a screen for selecting purchase request commodities and a shop (step S39).

On the other side, if the menu is selected at the step S15 (step S15: No route), that is, if the commodity order processing button 800 in FIG. 8 is pushed, the user terminal 3 transmits to the intermediation server 5, commodity order processing selection information (step S37). In response to receipt of this information, the intermediation server 5 executes the step S39.

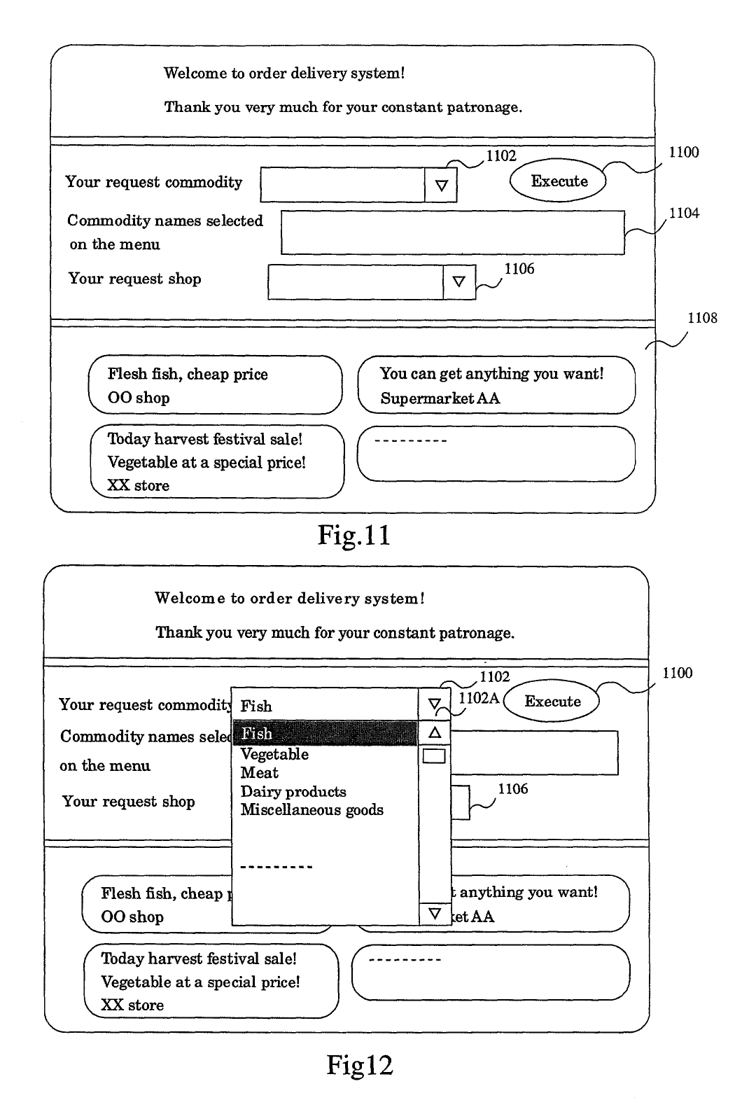

If the intermediation server 5 executes the step S39, the user terminal 3 receives and displays on the display device, the display information for the screen for selecting purchase request commodities and shop (step S41). FIG. 11 shows an example of the screen for selecting purchase request commodities and shops. In the example of FIG. 11, a combo box 1102 for selecting commodities other than commodities selected on the menu, a display column 1104 for displaying commodity names of commodities selected on the menu, a combo box 1106 for selecting a requested shop, an advertisement display column 1108 for each shop and an execution button 1100 to transmit the selection result are included.

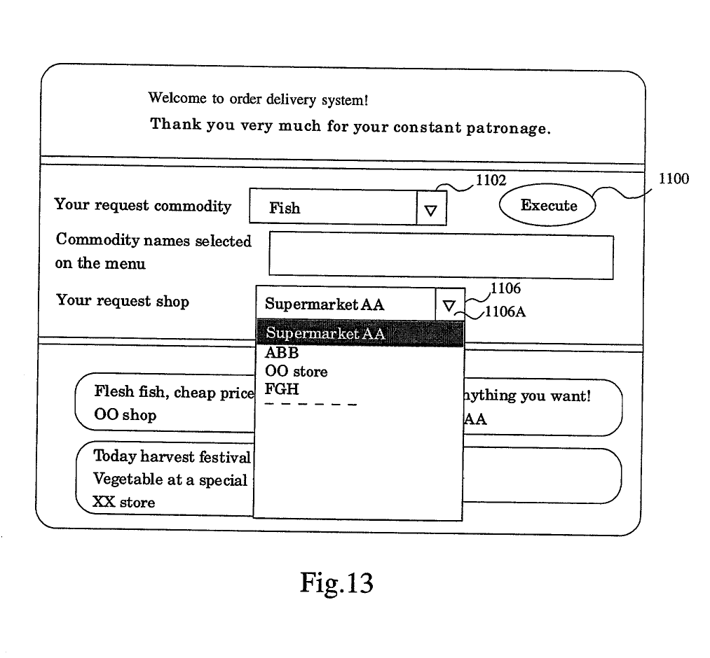

As shown in FIG. 12, the user operates the user terminal 3, and selects one or a plurality of commodities from a menu opened in response to the push of a button 1102A of the combo box 1102. In the example of FIG. 12, “fish” is selected. Thus, the robot 73 moves to the fish corner in a shop, which will be selected below. In addition, as shown in FIG. 13, the user operates the user terminal 3, and selects one shop or store from a menu opened in response to the push of a button 1106A of the combo box 1106. In the example of FIG. 13, a supermarket AA is selected. Thus, the robot 73 in the supermarket AA works.

When the user decides the purchase request commodities and the shop (store), he or she clicks the execution button 1100. In response to this click, the user terminal 3 transmits to the intermediation server 5, shop/commodity selection information (step S45). The display communication processing unit 51 in the intermediation server 5 receives from the user terminal 3 and stores into the storage device, the shop/commodity selection information (step S47).

Next, the processing shifts through terminals A and B from FIG. 7 to FIG. 14. The robot control information processing unit 52 in the intermediation server 5 transmits a login request (ID and password) to the shop server 71 in the selected shop (step S49). The shop server 71 receives the login request (ID and password) from the intermediation server 5, and performs authentication processing by using the ID and password (step S51). If the authentication fails, the shop server 71 notifies the intermediation server 5 of the failure. The robot control information processing unit 52 in the intermediation server 5 transmits the login request, again. If the authentication is successful, the shop server 5 may transmit a notification indicating that the authentication is successful to the intermediation server 5.

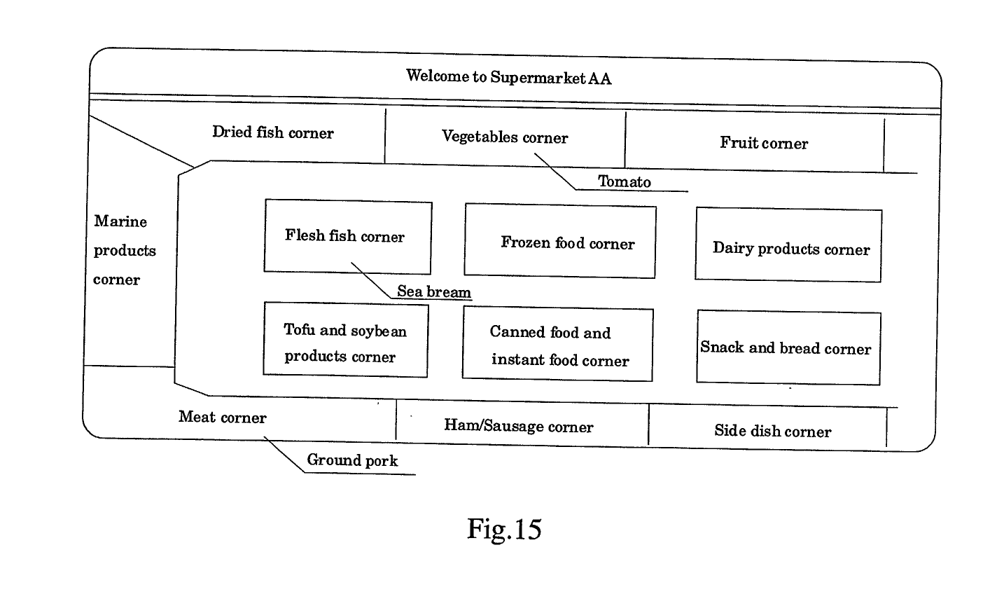

Next, the display communication processing unit 51 in the intermediation server 5 generates display information for a screen for showing an association figure between selected commodities and the corner layout within the shop, and transmits it to the user terminal 3 (step S53). The figure for the corner layout within the shop is read out from the storage device by referring to the in-store layout information table 113. The user terminal 3 receives the display information for the screen for showing an association figure between selected commodities and the corner layout within the shop, and displays it on the display device (step S55). FIG. 15 shows an example of the screen for showing an association figure between selected commodities and the corner layout within the shop. In the example of FIG. 15, a case in which the purchase request commodities (selected commodities) are a tomato, a sea bream, and ground pork is indicated. In such a case, the vegetable corner, the flesh fish corner and the meat corner may be colored or blinked to indicate an association between the corner layout within the shop and the purchase request commodities.

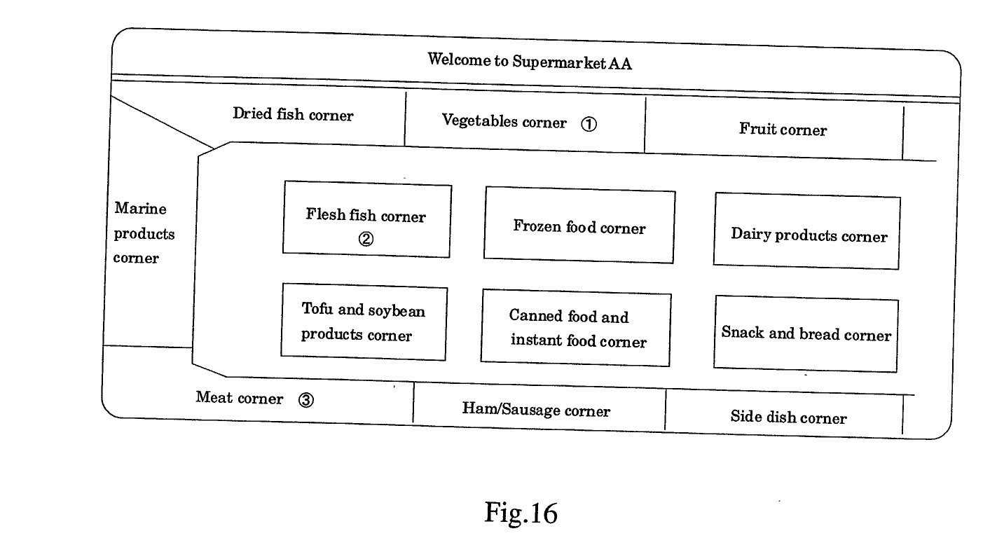

Next, the robot control information processing unit 52 in the intermediation server 5 performs a processing for optimizing a route to move around corners of the selected commodities (step S56). For example, it is possible to determine the route so as to minimize the moving distance of the robot 73, or so as to surely pass through the front of the corners of commodities especially recommended by the shop. Anyway, this moving route optimization processing is not changed from the conventional art. Therefore, further explanation is omitted. As for the example of FIG. 15, as described in FIG. 16, the first is the vegetable corner, the second is the flesh fish corner, and the third is the meat corner.

Then, if the moving route is determined, the robot control information processing unit 52 in the intermediation server 5 transmits information indicating the moving route to the shop server 71 (step S57). In response to the transmission, the shop server 71 receives the information indicating the moving route, and instructs the robot 73 to move according to the moving route (step S59). The robot 73 starts moving according to the instruction from the shop server 71. When it starts moving, a camera installed in the robot also starts photographing images. Then, the robot 73 continuously transmits to the shop server 71 images photographed while moving and the shop server 71 transmits images to the intermediation server 5 (step S61). The image information relay processing unit 54 in the intermediation server 5 receives from the shop server 71, images photographed while the robot 73 is moving (step S63), cooperates with the display communication processing unit 51, and transmits to the user terminal 3, display information including an image for the corner layout within the shop and an image photographed while moving (step S65). The information for the corner layout within the shop is read out from the storage device 11 by referring to the in-store layout information table 113. The display communication processing unit 51 may transmit information for the corner layout within the shop and a frame for an image photographed while moving, and the image information relay processing unit 54 may transmit the image photographed while moving to the user terminal 3. In addition, it is also possible that the shop server 71 acquires a destination address (for example, an IP address of the user terminal 3) of the image photographed while moving from the robot control information processing unit 52 in the intermediation server 5, and the shop server 71 directly transmits to the user terminal 3, the image photographed while moving via the network 1.

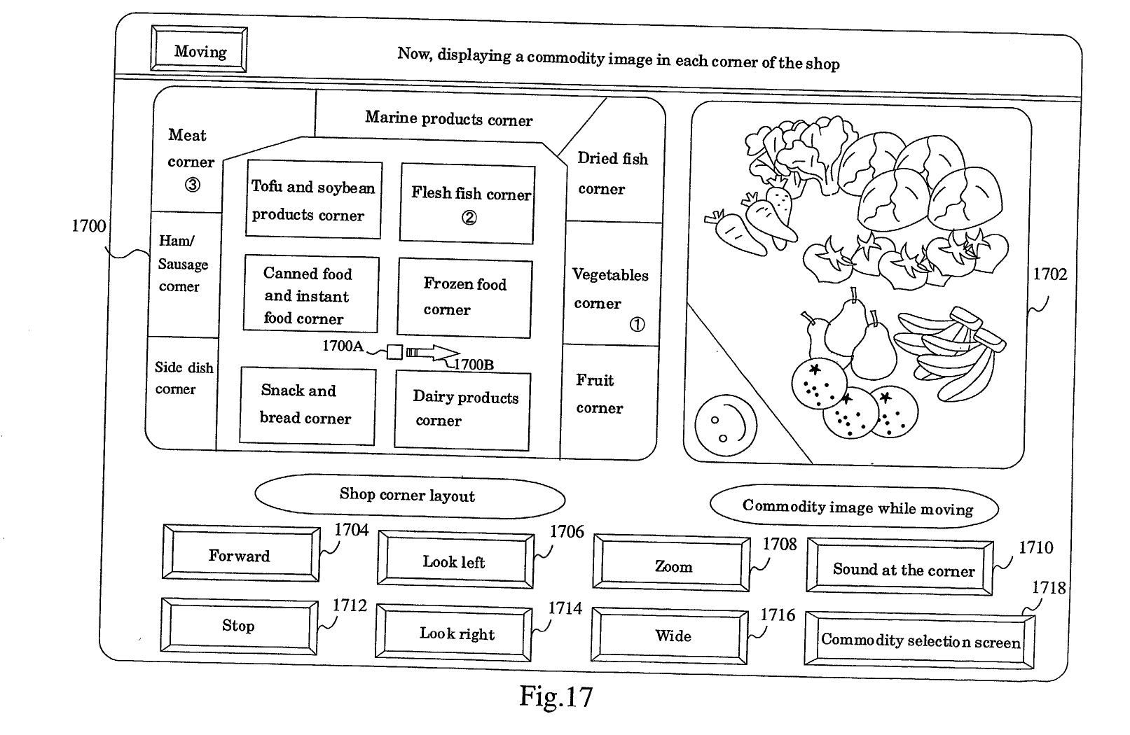

The user terminal 3 receives from the intermediation server 5, the display information including an image for the corner layout within the shop and an image photographed while moving, and displays it on the display device (step S67). FIG. 17 shows an example of this screen. In the example of FIG. 17, a part 1700 provided on the left side for displaying the corner layout within the shop (the in-store corner layout), as shown in FIG. 16, a part 1702 provided on the right side for displaying the image wile moving (the commodity image photographed while moving), a “forward” button 1704 for causing the robot 73 to go forward, a “look left” button 1706 for causing the robot 73 to photograph the left-hand side, a zoom button 1708 for causing the robot 73 to photograph in a zoom-in or zoom-out mode, a “sound at the corner” button 1710 for causing the robot 73 to acquire the sound at the corner in addition to the image information, a “stop” button 1712 for causing the robot 73 to stop, a “look right” button 1714 for causing the robot 73 to photograph the right-hand side, a wide button 1716 for causing the robot 73 to photograph the wide image and a commodity selection screen button 1718 to return to the commodity selection screen (FIG. 12).

Since in the part 1700 for displaying the corner layout within the shop, the present position 1700A and forwarding direction 1700B of the robot 73 can be displayed, the intermediation server 5 can indicate the user how the robot 73 is moving within the shop and can display the image photographed while the robot 73 is moving. Therefore, it can give the user a feeling as if he or she actually went to shopping. In addition, it is possible for the user to give the robot 73, which is moving, commands, such as forward, stop, look (photograph) left or right, zoom, wide, get sound and so on. Therefore, the user can look at commodities other than the purchase plan commodities, for example. In this point, it is possible to give the user a feeling as if he or she actually went to shopping, and it is also possible for the shop to give the user a motivation to purchase more or other commodities.

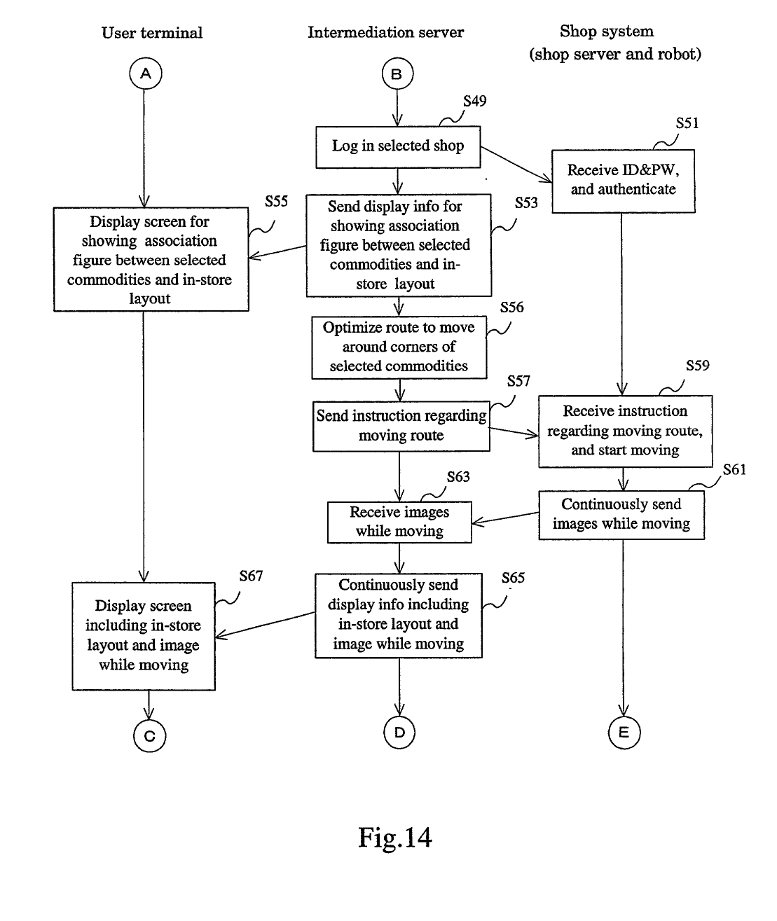

The processing shifts through terminal C, D and E in the FIG. 14 from FIG. 14 to FIG. 18. It is assumed that on the display device of the user terminal 3, display information including the corner layout within the shop and the image photographed while moving is displayed, and the user pushes any of the function buttons. In this case, the user terminal 3 accepts the selection input of the function button on the screen, and transmits to the intermediation server 5, the selection information for the function button (step S69). The robot control information processing unit 52 in the intermediation server 5 receives the selection information for the function button from the user terminal 3 (step S71), and transmits an execution command for the selected function to the shop server 71 (step S73). The shop server 71 receives the execution command for the selected function from the intermediation server 5 (step S75), and controls the robot 73 so as to perform operations according to the execution command. The robot 73 works according to control commands by the shop server 71 (step S77). The robot 73 photographs images while working and after working, and continuously transmits image information to the shop server 71. The shop server 71 also transmits the image information to the image information relay processing unit 54 in the intermediation server 5 (step S79).

The image information relay processing unit 54 in the intermediation server 5 receives the image information photographed while working from the shop server 71 (step S81), cooperates with the display communication processing unit 51, and continuously transmits to the user terminal 3, the display information including the corner layout within the shop and the image information photographed while working (step S83). In response to the transmission, the user terminal 3 receives and displays on the display device, the display information including the corner layout within the shop and the image information photographed while working (step S85). Here, it is judged whether the function button, which is pushed next, is the commodity selection screen button 1718 (step S87). If the function button, which is pushed next, is not the commodity selection screen button 1718, the processing returns to the step S69. On the other side, if the function button, which is pushed next, is the commodity selection screen button 1718, the user terminal 3 transmits the selection information for the commodity selection screen button 1718 to the intermediation server 5 (step S89). The display communication processing unit 51 in the intermediation server 5 receives from the user terminal 3, the selection information for the commodity selection screen button 1718 (step S91). The processing returns to FIG. 7 through terminal F.

Thus, the robot 73 photographs while moving in the shop until it reaches the corner for the purchase plan commodity. It is possible for the user to cause the robot 73 to look the other way or to stop to photograph the surrounding. It is also possible for the user to hear the sound and voice within the shop. With this function, it becomes possible that the user enjoys an atmosphere within the shop.

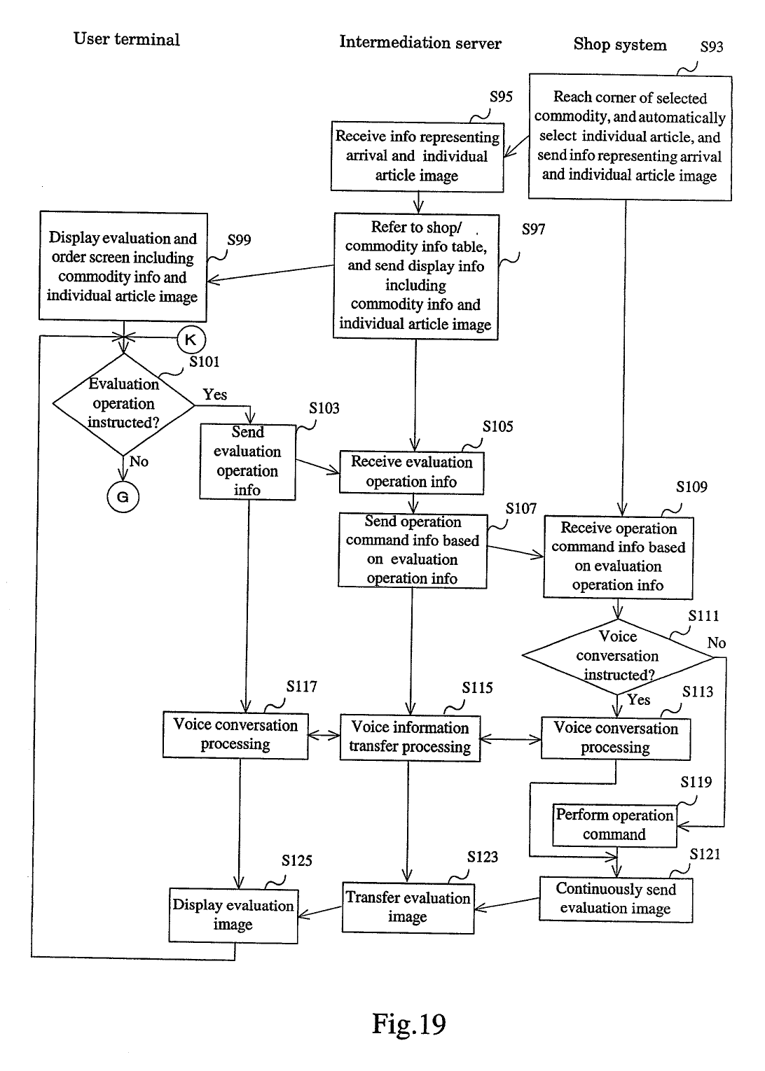

Next, the processing in a case in which the robot 73 reaches the corner of the purchase plan commodity (selected commodity) is explained using FIG. 19 and the subsequent figures. Firstly, when the robot 73 reaches the corner of the purchase plan commodity (selected commodity), it automatically selects one individual article of the selected commodity. Then, the robot 73 photographs an image of the individual article, and transmits to the shop server 71, information representing the arrival and the image of the individual article. The shop server 71 transmits to the intermediation server 5, the information representing the arrival and the image of the individual article (step S93). The display communication processing unit 51 in the intermediation server 5 receives from the shop server 71, the information representing the arrival and the image of the individual article (step S95), and outputs the information representing the arrival to the robot control information processing unit 52. In addition, it outputs the image information to the image information relay processing unit 54. The display communication processing unit 51 refers to the shop/commodity information table 115, and retrieves the commodity information. Then, the display communication processing unit 51 and the image information relay processing unit 54 cooperates, and transmits to the user terminal 3, display information for a screen for the evaluation and order, which includes the commodity information and the image information of the individual article (step S97).

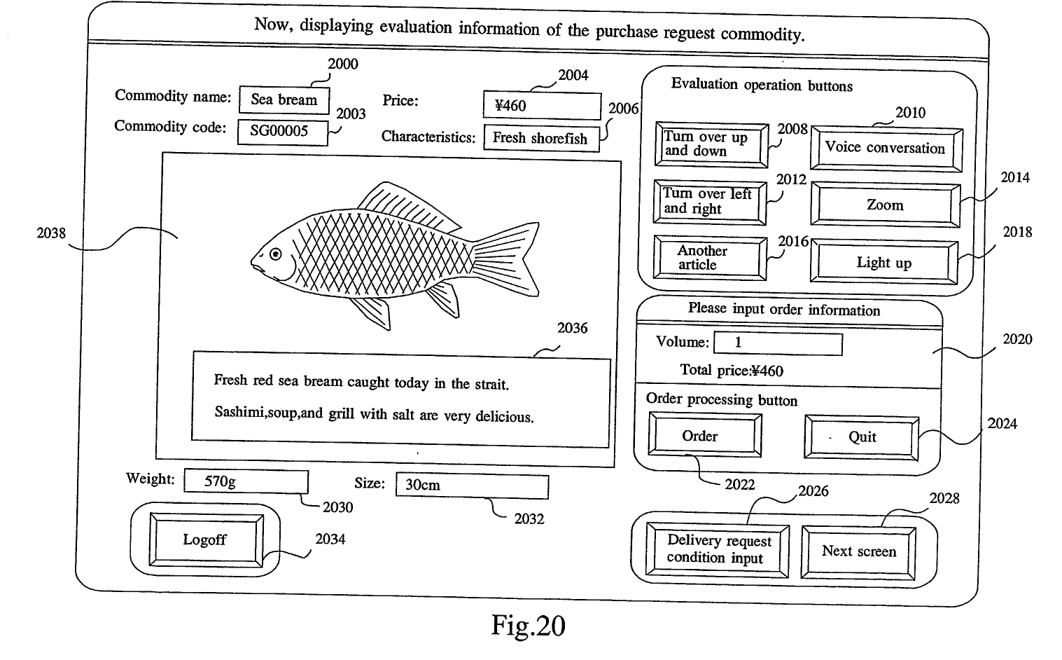

The user terminal 3 receives from the intermediation server 5, the display information for the screen for the evaluation and order, which includes the commodity information and the image information of the individual article, and displays it on the display device (step S99). FIG. 20 shows an example of the screen for the evaluation and order. In the example of FIG. 20, a commodity name display column 2000 for displaying the name of the commodity, which is stored in the shop/commodity information table 115, a commodity code column 2003 for displaying the commodity code stored in the shop/commodity information table 115, a price display column 2004 for displaying the price of the commodity, which is stored in the shop/commodity information table 115, a characteristics display column 2006 for displaying the characteristics information of the commodity, which is stored in the shop/commodity information table 115, a “turn over up and down” button 2008 for causing the robot 73 to turn over the individual article up and down to look at the reverse side of the individual article for the evaluation, a voice conversation instruction button 2010 for performing the conversation with a clerk in the corner, a “turn over left and right” button 2012 for causing the robot 73 to turn over the individual article the left and right for the evaluation, a zoom instruction button 2014 for causing the robot 73 to get a zoom image, an another article button 2016 for causing the robot 73 to select another individual article, a lightening button 2018 for lightening by the light to easily look at the individual article, an order number input column 2020 for inputting the number of individual articles to be ordered, an order button 2022 for ordering, a quit purchase button 2024, which is pushed if the user decides not to purchase the purchase plan commodity, a “delivery request condition input” button 2026 for inputting the delivery request condition, a “next screen” button 2028 for shifting to the purchase of the next purchase plan commodity, an image display part 2038 for displaying the image information of the individual article at this time, a message display column 2036 for displaying the recommendation message stored in the shop/commodity information table 115, a weight display column 2030 and a size display column 2032 for displaying weight and size information measured by a measuring instrument installed, for example, in the robot 73, and a logoff button 2034 for ending the commodity purchase operation using the robot 73 are included.

The user can get general information of the commodity from the commodity name, the price, the commodity code, the characteristics information, and the recommendation message. In addition, the user can get information peculiar to the individual article from information in the image display part 2038 for the individual article and information regarding the weight and size measured by the measuring instrument installed in the robot 73. In addition, the user can instruct an evaluation operation to the robot 73. By instructing, for example, to turn over up and down, to turn over left and right, to change the light, to zoom in or to zoom out, the user can instruct an arbitrary display manner, can look at the image states, which are changing according to the instructions, and can examine the quality of the individual article. In addition, if the user does not like the individual article, by clicking the “another article” button 2016, the user can instruct to select another individual article. The user also can have the robot 73 perform operations as if the user took a lot of individual articles in his or her hand at the corner, looked at them, and purchased the best one. The number of kinds of evaluation operations may be more or less than the level shown above. In addition, the robot 73 may include a measuring instrument, which measures a value representing the weight, the size, or other freshness. Such a measuring instrument may not be provided, and general information about the commodity may be indicated to the user. Furthermore, if the order volume is set to 2 or the number larger than 2 and the order button 2022 is clicked, the evaluation operation for another individual article may be repeated until the number of selected articles reach the order volume.

Returning to the explanation of FIG. 19, if the display shown in FIG. 20 is performed, it assumes that the user clicks any of buttons. If the user instructs the evaluation operation (step S101: Yes route), the user terminal 3 transmits to the intermediation server 5, information representing the selection of the evaluation operation (step S103). If a button other than the evaluation operation button is clicked, the processing shifts via terminal G from FIG. 19 to FIG. 21.

The robot control information processing unit 52 in the intermediation server 5 receives the information representing the selection of the evaluation operation (step S105), and transmits to the shop server 71, operation command information based on the information representing the selection of the evaluation operation (step S107). That is, if the user instructs the “turning over up and down” operation, the robot control information processing unit 52 transmits to the shop server 71, the operation command information for that operation. If the shop server 71 receives the operation command information from the intermediation server 5 (step S109), it controls the robot 73 in accordance with the received operation command information if the operation command information does not represent the voice conversation instruction (step S111: No route). The robot 73 works according to the control of the shop server 71 (step S119).

On the other side, if the operation command information represents the voice conversation instruction (step S111: Yes route), the shop server 71 instructs the robot 73 to enable the voice conversation. The robot 73 sets the switch of the microphone ON, and converts information concerning the voice to the electric signal. Then, the electric signal is transmitted as voice information to the shop server 71. In addition, the robot 73 sets the speaker ON, and outputs from the speaker the voice information sent from the shop server 71. Thus, the robot 73 performs input or output processing of the voice information, and the shop server 71 also receives and transmits the voice information (step S113). The image information relay processing unit 54 in the intermediation server transfers the voice information from the shop server 71 to the user terminal 3, and the voice information from the user terminal 3 to the shop server 71 (step S115). The user terminal 3 reproduces from the speaker, the voice information from the shop server 71, and gets the voice information from the microphone and transmits it to the intermediation server 5 (step S117).

The robot 73 photographs regardless of performing the voice conversation processing or not. The robot 73 gets the evaluation image information and transmits it to the shop server 71. The shop server 71 continuously transmits the evaluation image information (for example, information shown in the image display part 2038 in FIG. 20) to the intermediation server 5 (step S121). The image information relay processing unit 54 in the intermediation server 5 receives the evaluation image information from the shop server 71, and transfers it to the user terminal 3 (step S123). The user terminal 3 receives from the intermediation server 3, the evaluation image information, and displays it on the display device (step S125). Thus, the display contents of the image information display part 2038 in FIG. 20 are updated. During the evaluation, the processing returns to the step S101, evaluation operations are performed.

Thus, by using the interface shown in FIG. 20, it becomes possible for the user to instruct to display an arbitrary display manner and to get the image information of the individual article at this moment.

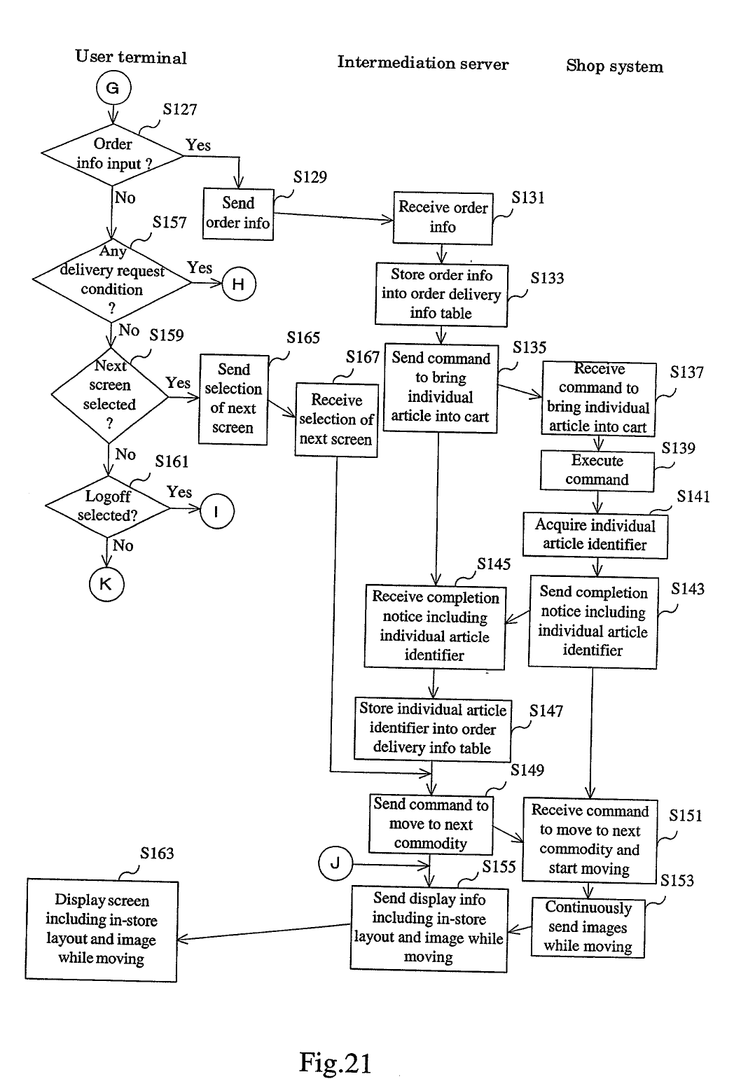

Next, a processing flow in a case in which an operation other than the evaluation operation is instructed if the screen as shown in FIG. 20 is displayed is explained using FIG. 21 to FIG. 25. If the user inputs order information including the commodity code, volume, and the order instruction (step S127: Yes route), the user terminal 3 transmits the order information to the intermediation server 5 (step S129). The order processing unit 53 receives the order information (step S131), and stores the order information into the order delivery information table 117 (step S133). In addition, by referring to the member information table 111, the order processing unit 53 stores necessary information into the order delivery information table 117. Then, the robot control information processing unit 52 transmits to the shop server 71, a command to bring the individual article the user instructed the robot 73 to purchase into a shopping cart (step S135).

The shop server 71 receives the command to bring the individual article the user instructed to purchase into the shopping cart (step S137), and controls the robot 73 to bring it into the cart (step S139). The cart is a shopping cart the robot 73 has or which is attached to the robot 73. The individual article input into this shopping cart is an object to be purchased later as far as a command to bring it out is particularly input. When the robot 73 brings the individual article into the cart, it acquires identification information of the individual article (step S141). For example, if the identification information is attached to the individual article by the barcode, the robot 73 gets the identification information by reading out the barcode. If the identification information is not preliminarily assigned to the individual article, the robot 73 provides the identification information for the individual article, for example, the robot 73 pastes a tag with the barcode onto the individual article.

Then, the robot 73 transmits to the shop server 71, a notification representing the completion of the bringing operation into the cart and the identification information of the individual article. The shop server 71 transmits to the intermediation server 5, a command completion notification including the identification information of the individual article (step S143). The display communication processing unit 51 in the intermediation server 5 receives from the shop server 71, the command completion notification including the identification information of the individual article (step S145), and outputs the command completion notification to the robot control information processing unit 52. The display communication processing unit 51 stores the identification information of the individual article into the order delivery information table 117 (step S147). Then, the robot control information processing unit 52 transmits to the shop server 71, a command for causing the robot 73 to move to the next commodity (step S149). The shop server 71 receives the command for causing the robot 73 to move to the next commodity from the intermediation server 5, and controls the robot 73 to start moving to the corner of the next commodity (step S151). The robot 73 takes images while moving and continuously transmits the images to the shop server 71. The shop server 71 also continuously transmits the images photographed while moving to the intermediation server 5 (step S153).

If the display communication processing unit 51 in the intermediation server 5 receives the images photographed while moving from the shop server 51, it gets the information regarding the corner layout within the shop by referring to the in-store layout information table 113, and outputs the images photographed while moving to the image information relay processing unit 54. Then, the display communication processing unit 51 and the image information relay processing unit 54 cooperates, and generates the display information such as FIG. 17 including the corner layout within the shop and the images photographed while moving, and transmits it to the user terminal 3 (step S155).

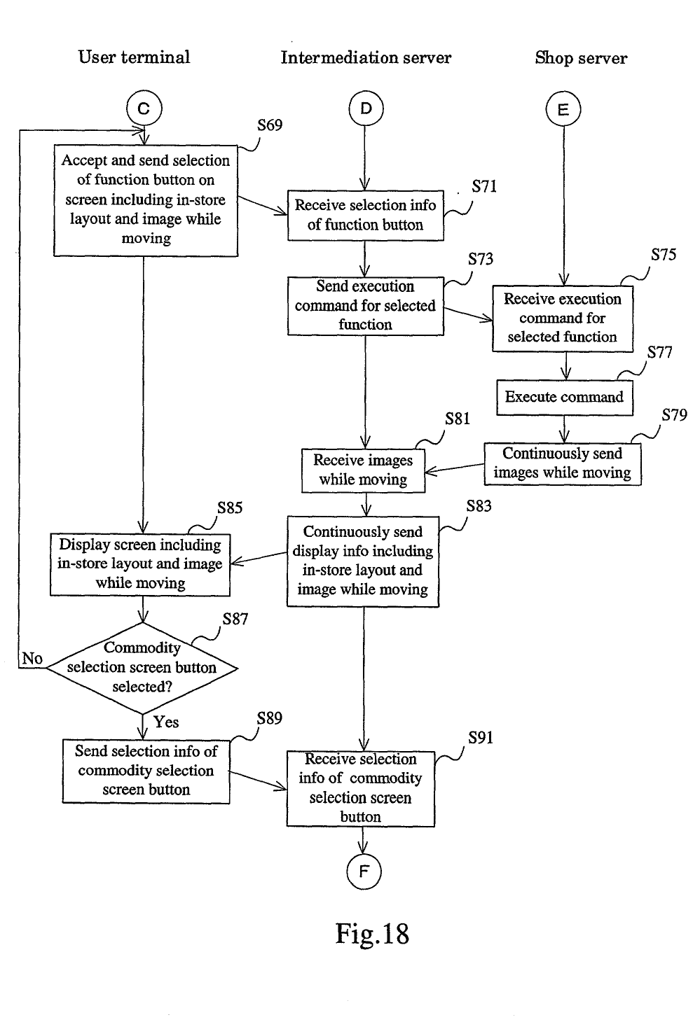

The user terminal 3 receives from the intermediation server 5, the display information including the corner layout within the shop and the images photographed while moving, and displays it on the display device (step S163). In addition, until the robot 73 arrives at the corner of the next commodity, the processing is performed according to the flow shown in FIG. 18, for example.

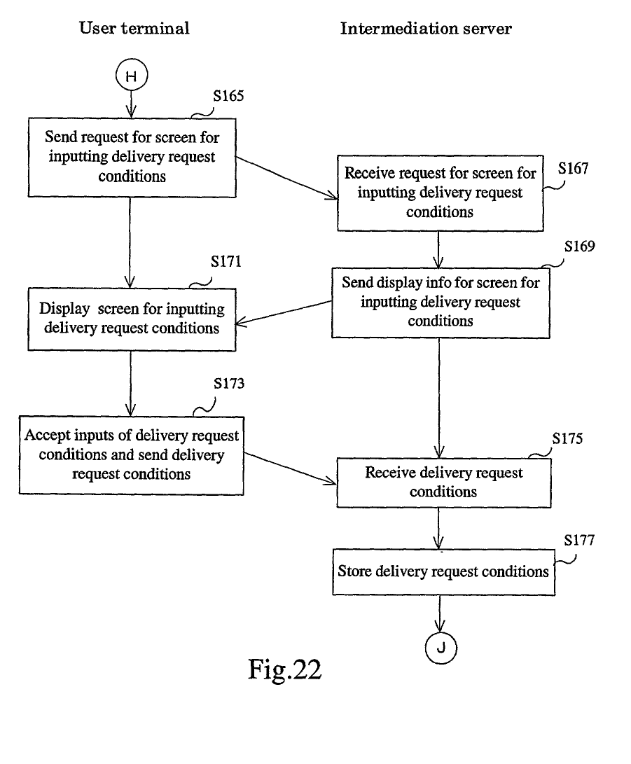

On the other side, if the user clicks the delivery request condition input button 2026 (step S157: Yes route) instead of the order information input in FIG. 20 (step S127: No route), the processing shits through terminal G from FIG. 21 to the processing flow shown in FIG. 22. On the other side, if the next screen button 2028 is clicked (step S157: Yes route) instead of the delivery request condition input button 2026 (step S157: No route), the user terminal 3 transmits to the intermediation server 5, information representing the selection of the next screen (step S165). The robot control information processing unit 52 in the intermediation server 5 receives from the user terminal 3, the information representing the selection of the next screen (step S167), and the processing shifts to the step S147. That is, the processing shifts to the processing as to the next commodity.

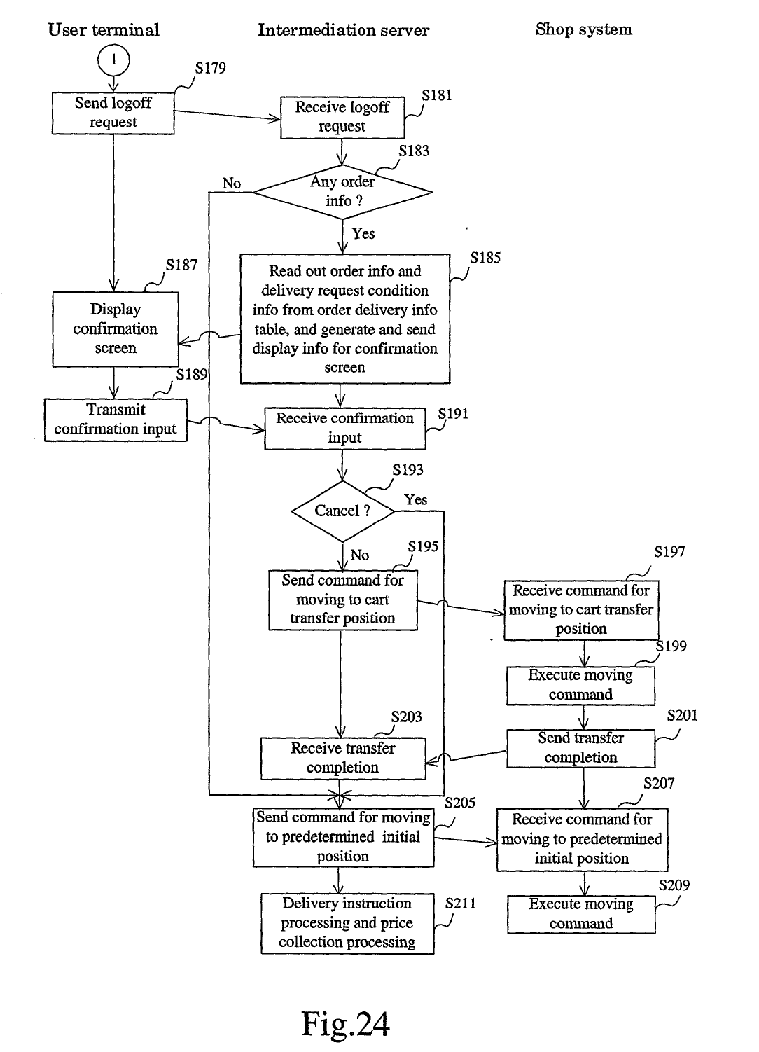

If the logoff button 2034 is clicked (step S161: Yes route), instead of the next screen button 2028 (step S159: No route), the processing shifts through terminal I from the FIG. 21 to the processing shown in FIG. 24. If the logoff button 2034 is not clicked, the processing returns through terminal K to the step 101 in FIG. 19.

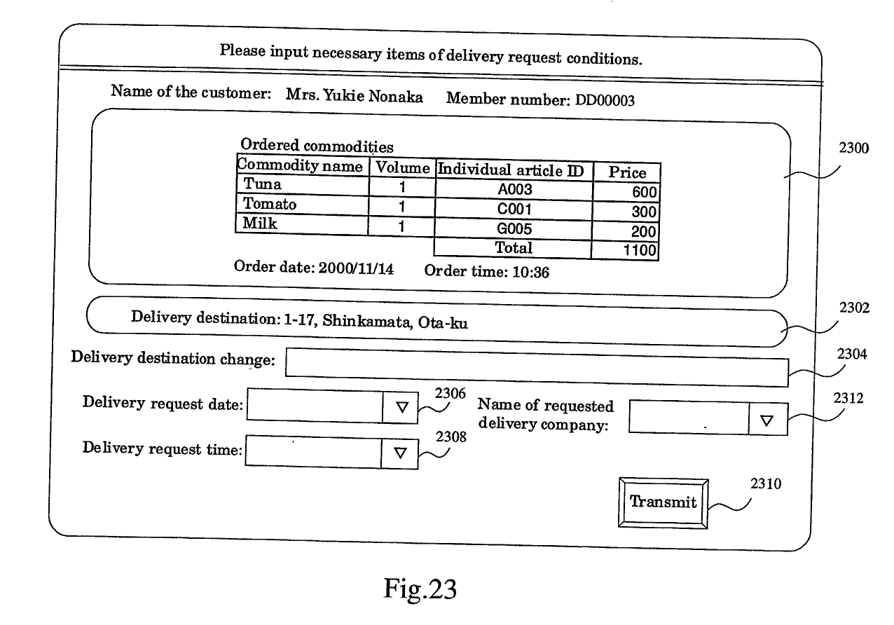

Next, a processing flow if the user clicks the delivery request condition input button 2026 on FIG. 20 is explained using FIG. 22. In this case, the user terminal 3 transmits to the intermediation server 5, a request for a screen for inputting the delivery request condition (step S165). The display communication processing unit 51 in the intermediation server 5 receives the request for the screen for inputting the delivery request condition (step S167), and generates display information for the screen for inputting the delivery request condition by referring to the order delivery information table 117, and transmits it to the user terminal 3 (step S169). The user terminal 3 receives from the intermediation server 5, the display information for the screen for inputting the delivery request condition, and displays the screen on the display device (step S171). FIG. 23 shows an example of the screen for inputting the delivery request condition. In the example of FIG. 23, the user name (the customer name), the member ID, an order information display column 2300, a delivery destination information display column 2302, which includes the default delivery destination, an input column 2304 for the delivery destination change, a combo box 2306 for selecting a delivery request date, a combo box 2312 for selecting a requested delivery company name, a combo box 2308 for selecting the delivery request time, and a “transmit” button 2310.

The order information display column 2300 includes information to confirm the order (commodity name, volume, individual article identifier (identification information), price, total price, order date, and order time). The reason why the individual article identifier is included is to enable the user to confirm that, when the delivery of the commodity is actually performed and the user looks at the delivered commodity at his or her hand, it is really that commodity, which was looked through the robot 73. As for the input column 2304 for the delivery destination change, it is possible to enable the user to directly input data or to enable the user to select any of some delivery destinations, which are pre-registered.

In this example, as for the delivery request date, the requested delivery company, and the delivery request time, because a possible date, delivery company and time are determined according to the order date and the delivery route of the delivery company, the combo boxes are used.

Returning to FIG. 22, the user inputs to the user terminal 3, the delivery request conditions on the screen such as in FIG. 23. The user terminal 3 accepts the inputs of the delivery request conditions, and transmits information of the delivery request conditions to the intermediation server 5 (step S173). The order processing unit 53 in the intermediation server 5 receives the information of the delivery request conditions (step S175), and registers the information of the delivery request conditions into the order delivery information table 117 (step S177). Then, the processing returns through terminal J to step S155 in FIG. 21.

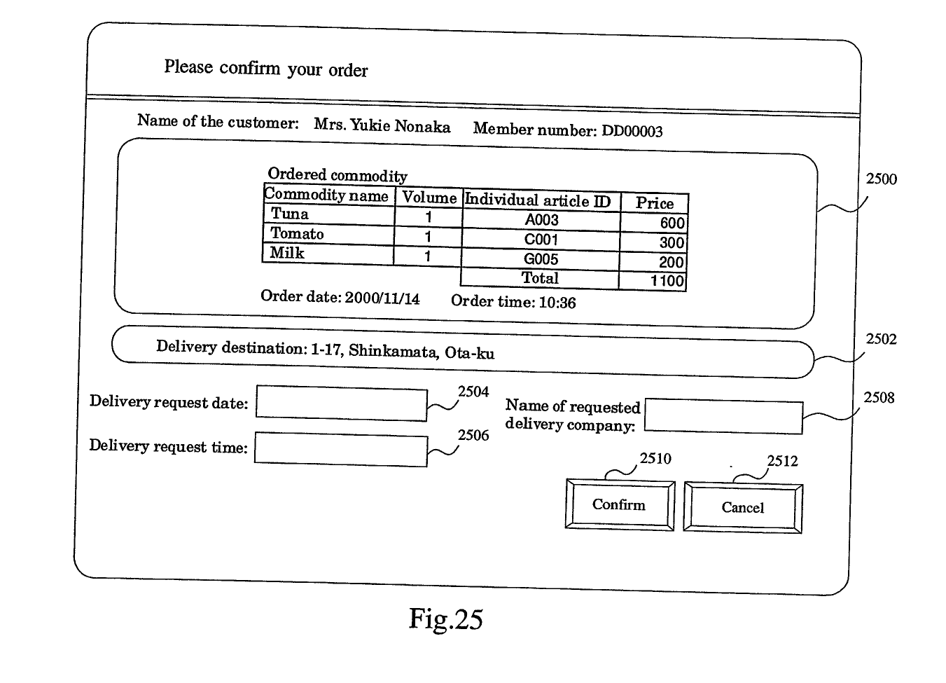

Next, a processing flow if the logoff is selected in FIG. 21 (terminal I) is explained using FIG. 24 and FIG. 25. If the user clicks the logoff button 2034 when the screen of FIG. 20 is displayed, the user terminal 3 transmits a logoff request to the intermediation server 5 (step S179). The order processing unit 53 in the intermediation server 5 receives the logoff request (step S181), refers to the order delivery information table 117 and confirms whether or not the order information is included in the table 117 (step S183). If the order information is included, the order processing unit 53 reads out the order information and the information of the delivery request conditions, generates display information for a confirmation screen, and transmits it to the user terminal 3 (step S185).

The user terminal 3 receives the display information for the confirmation screen and displays the confirmation screen on the display device (step S187). An example of the confirmation screen is shown in FIG. 25. In the example of FIG. 25, the user name and the member ID, an order contents display column 2500, a delivery destination address display column 2502, a delivery request date display column 2504, a requested delivery company name display column 2508, a delivery request time display column 2506, a confirmation button 2510, and a cancel button 2512 are included. In the order contents display column 2500, ordered commodity names, volumes, individual article identifiers, prices, a total price, an order date and order time are included. It is also possible to enable the user to change the order contents in this confirmation screen. Similarly, it is also possible to enable the user to change the delivery destination, the delivery request date, the requested delivery company and the delivery request time.

The user looks at the confirmation screen, and clicks the confirmation button 2510 if there is no problem. If any modification is required, the user clicks the confirmation button 2510 after the modification is input. If the whole of the order is canceled, the user clicks the cancel button 2512. The user terminal 3 transmits to the intermediation server 5, the input by the user as a confirmation input (step S189). The order processing unit in the intermediation server 5 receives from the user terminal 5, the confirmation input (step S191). Then, if the confirmation input includes the modified order information, the order delivery information table 117 is updated. If the confirmation input means cancel (step S193: Yes route), the processing shifts to the step S205. On the other side, if the confirmation input does not mean cancel (step S193: No route), the robot control information processing unit 52 transmits to the shop server 71, a command for causing the robot 73 to move to the cart transfer position (step S195). If there is no modification for the order information, the command for causing the robot 73 to move to the cart transfer position is simple. However, if there is any excluded article from the ordered articles, information including an individual article identifier of the excluded article is also transmitted to the shop server 71.

The shop server 71 receives from the intermediation server 5, the command for causing the robot 73 to move to the cart transfer position (step S197), and controls the robot 73 to move to the cart transfer position. The robot 73 has its cart move to the transfer position according to the control by the shop server 71 (step S199). If there is any excluded article from the ordered articles, the shop server 71 receives the individual article identifier of the excluded article. Then, the shop server 71 may control the robot 73 to bring out the excluded article from the cart. If the robot 73 moves to the transfer position, it requests a shop clerk or another robot at the transfer position to perform a delivery preparation, and transfers articles in the cart to the shop clerk. If such an operation is completed, the robot 73 transmits information regarding the transfer completion to the shop server 71. The shop clerk accesses the intermediation server 5 from the shop server 71, refers to the order delivery information table 117, confirms the order contents, the delivery company name, the delivery date and time and so on, and packs and ships the ordered commodities.

If the shop server 71 receives the information regarding the transfer completion of the commodities, it transmits the information to the intermediation server 5 (step S201). If the robot control information processing unit 52 in the intermediation server 5 receives the information regarding the transfer completion (step S203), it transmits to the shop server 71, a moving command for causing the robot 73 to move to a predetermined initial position (step S205). In addition, at a timing when the information regarding the transfer completion is received or when it is confirmed at the step S191 that the received confirmation input does not mean cancel, necessary information is extracted from the member information table 111 and the order delivery information table 117, and is stored into the price collection management table 119.

If the shop server 71 receives from the intermediation server 5 (step S207), the moving command for causing the robot 73 to move to the predetermined initial position, it controls the robot 73 to move to the predetermined initial position. The robot 73 moves to the predetermined initial position according to the control by the shop server 71 (step S209).

The delivery instruction processing unit 56 in the intermediation server 5 refers to the order delivery information table 117, extracts the order information such as commodities, shop, delivery request date and time, etc., of an order, which is performed this time, and transmits a delivery request to the delivery company server 9 (step S211). If the delivery company server 9 receives the delivery request, it assigns a person in charge of the delivery to this delivery request. The assigned person in charge of the delivery collects the ordered commodities at the shop or store, and delivers them to their delivery destinations according to the delivery request date and time. If the user selects a settlement method in which the price for the ordered commodities is paid by cash when the commodities are transferred to the user, the person in charge of the delivery collects cash from the user, and inputs into the delivery company server 9, the fact the collection is completed. The delivery company server 9 transmits to the intermediation server 5, the price collection information.

If the price collection processing unit 55 receives the price collection information from the delivery company server 9, it reflects the status of the collection to the price collection management table 119. The price collection processing unit 55 records the completion of the price collection when information is stored into the price collection management table 119 in principle, if the settlement method is by the credit card, or by debiting against the bank account.

As described above, this embodiment can give the user image information as if he or she walked around in the shop, and can raise the purchasing interest for commodities other than the purchase plan commodities. In addition, it becomes possible for the user to evaluate individual articles among the same kind of articles by looking at the image information for each article available at this moment, and to select and purchase the most favorite individual article. Furthermore, since the user can instruct the robot 73 to get various display manners, it becomes possible to give the user a feeling as if he or she actually examined individual article at his or her hand in the shop. In addition, it is possible to select commodities from the cooking menu. Therefore, it is possible to support the shopping by a person who cannot decide what to cook. In addition, the intermediary who manages the intermediation server 5 can get membership fees from members and/or advertisement charges and intermediation fees from shops by providing such a new service. The shop can expect the increase of the turnover because of the enhancement of shop users. Because the robot is used, the shop can introduce this new service with low labor costs.

One embodiment of the present invention is explained above. However, the present invention is not limited to this embodiment. Especially, the screens shown in figures are mere examples. It is possible to change to other display manners, which includes similar contents. In addition, the robot 73 does not have to be a robot, which walks by two legs, as shown in FIG. 1, and may have a shape favorable to perform shopping. The separation of functions within the intermediation server 5 is also arbitrary.

In addition, tables shown in FIG. 2 to FIG. 6 are also mere examples. More or less kinds of data may be stored in these tables.

Furthermore, because the price collection processing and delivery processing heavily depend on the delivery system including the delivery company server 9, it is possible to variously transform the above described examples.

The above-described system may be implemented by installing programs for performing processing described above into a computer hardware. In this case, the programs are stored on a storage medium, such as a flexible disk, a CD-ROM or a magneto-optical disk, or in a storage device, such as a semiconductor memory or a hard disk. The programs may be distributed via a computer network. The intermediate processing results are temporarily stored in the memory.

As described above, the present invention can provide technology for providing an interface for customers in the online sale of commodities and etc. as if the customer actually went to a shop and evaluated each article according to the purchase request.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for selling a commodity via a network, said method comprising the steps of:
if instruction information regarding an arbitrary display manner of an arbitrary individual commodity selected by a user is received from a user terminal, outputting to an apparatus for photographing, a first photographing request for acquiring image information at this moment according to said arbitrary display manner of the selected individual commodity itself; and
transmitting to said user terminal, said image information of the selected individual commodity itself, said image information photographed by said apparatus for photographing.

2. The method set forth in claim 1, further comprising the steps of:
if information regarding a selected purchase plan commodity is received from said user terminal, outputting to said apparatus for photographing, a second photographing request for acquiring image information for said selected purchase plan commodity; and
transmitting to said user terminal, image information for said selected purchase plan commodity, which is photographed by said apparatus for photographing, and image information until said selected purchase plan commodity is photographed by said apparatus for photographing.

3. The method set forth in claim 1, wherein said apparatus for photographing includes a robot provided for a shop, and
said method further comprises the steps of:
according to said first photographing request, controlling said robot to change a photographing method for the selected individual commodity itself; and
if a purchase instruction of the selected individual commodity is received from said user terminal, instructing said robot to convey said selected individual commodity within said shop.

4. The method set forth in claim 2, wherein said apparatus for photographing includes a robot provided for a shop, and
said method further comprises a stop of:
according to said second photographing request, controlling said robot to move while photographing until said robot reaches an exhibition position of said selected purchase plan commodity.

5. The method set forth in claim 1, further comprising the steps of:
if a purchase instruction of the selected individual commodity is received from said user terminal, acquiring identification information of said selected individual commodity itself; and
transmitting said identification information of said selected individual commodity itself to said user terminal.

6. A method for purchasing a commodity via a network, said method comprising the steps of:
receiving from a server, and displaying on a display device, image information for an arbitrary individual commodity itself selected by a user;
according to an instruction input for an arbitrary display manner of the individual commodity itself by the user, transmitting to said server, instruction information regarding said arbitrary display manner; and
receiving from said server, and displaying on said display device, image information according to said arbitrary display manner of said individual commodity itself.

7. A computer program embodied on a medium, for causing a computer to sell a commodity via a network, said program comprising the steps of:
if instruction information regarding an arbitrary display manner of an arbitrary individual commodity selected by a user is received from a user terminal, outputting to an apparatus for photographing, a first photographing request for acquiring image information at this moment according to said arbitrary display manner of the selected individual commodity itself; and
transmitting to said user terminal, said image information of the selected individual commodity itself, said image information photographed by said apparatus for photographing.

8. The computer program set forth in claim 7, further comprising the steps of:
if information regarding a selected purchase plan commodity is received from said user terminal, outputting to said apparatus for photographing, a second photographing request for acquiring image information for said selected purchase plan commodity; and
transmitting to said user terminal, image information for said selected purchase plan commodity, which is photographed by said apparatus for photographing, and image information until said selected purchase plan commodity is photographed by said apparatus for photographing.

9. The computer program set forth in claim 7, wherein said apparatus for photographing includes a robot provided for a shop, and
said computer program further comprises the steps of:
according to said first photographing request, controlling said robot to change a photographing method for the selected individual commodity itself; and
if a purchase instruction of the selected individual commodity is received from said user terminal, instructing said robot to convey said selected individual commodity within said shop.

10. The computer program set forth in claim 8, wherein said apparatus for photographing includes a robot provided for a shop, and
said computer program further comprises a stop of:
according to said second photographing request, controlling said robot to move while photographing until said robot reaches an exhibition position of said selected purchase plan commodity.

11. The computer program set forth in claim 7, further comprising the steps of:
if a purchase instruction of the selected individual commodity is received from said user terminal, acquiring identification information of said selected individual commodity itself; and
transmitting said identification information of said selected individual commodity itself to said user terminal.

12. A computer system for selling a commodity via a network, comprising:
a receiver for receiving an instruction information regarding said arbitrary display manner of said arbitrary individual commodity selected by a user from a user terminal;
means for outputting to an apparatus for photographing, a first photographing request for acquiring image information at this moment according to said arbitrary display manner of said selected individual commodity itself, which is designated in said instruction information; and
a transmitter for transmitting to said user terminal, said image information of the selected individual commodity itself, said image information photographed by said apparatus for photographing.

13. The computer system set forth in claim 12, further comprising:
a second receiver for receiving information regarding a selected purchase plan commodity from said user terminal;
means for outputting to said apparatus for photographing, a second photographing request for acquiring image information for said selected purchase plan commodity in the received information; and
a second transmitter for transmitting to said user terminal, image information for said selected purchase plan commodity, which is photographed by said apparatus for photographing, and image information until said selected purchase plan commodity is photographed by said apparatus for photographing.

14. The computer system set forth in claim 12, wherein said apparatus for photographing includes a robot provided for a shop, and
said computer system further comprises:
a controller for controlling said robot to change a photographing method for the selected individual commodity itself, according to said first photographing request;
a third receiver for receiving a purchase instruction of the selected individual commodity from said user terminal; and
means for instructing said robot to convey said selected individual commodity within said shop in response to said purchase instruction.

15. The computer system set forth in claim 13, wherein said apparatus for photographing includes a robot provided for a shop, and
said computer system further comprises:
a second controller for controlling said robot to move while photographing until said robot reaches an exhibition position of said selected purchase plan commodity, according to said second photographing request.

16. The computer system set forth in claim 12, further comprising:
a fourth receiver for receiving a purchase instruction of the selected individual commodity from said user terminal;
means for acquiring identification information of said selected individual commodity itself in response to said purchase instruction; and
a third transmitter for transmitting said identification information of said selected individual commodity itself to said user terminal.
